(19) United States
(12) Patent Application Publication
(10) Pub. No.: US 2011/0122781 A1
(43) Pub. Date: May 26, 2011

(54) NETWORK DEVICE AND CONTROL METHOD THEREOF

(76) Inventors: Shang-Chih Chien, Hsinchu City (TW); Yung-Feng Chiu, Taichung City (TW); Hsiu-Che Chao, Taipei County (TW)

(21) Appl. No.: 12/702,295

(22) Filed: Feb. 9, 2010

(30) Foreign Application Priority Data
Nov. 24, 2009 (TW) 098139979

(51) Int. Cl. H04L 12/26; G06F 1/00

(52) U.S. Cl. 370/252; 713/300

(57) ABSTRACT

The present invention provides a network device and a control method thereof. The network device comprises: a receiver, a transmitter, a storage unit, and a processing unit. The storage unit is utilized for storing a software, and the processing unit is coupled to the receiver, the transmitter, and the storage unit, and utilized for reading the software from the storage unit and executing the software to execute following operations: calculating a first predetermined time and driving the transmitter to generate a network linking signal and output the network linking signal by the transmitter; polling a link status of the network device and a link partner to generate a first detecting result; and determining whether to power down the transmitter according to the first detecting result and the first predetermined time.

### BACKGROUND OF THE INVENTION

1. Field of the Invention

The present invention relates to a network device and control method thereof, and more particularly, to a network device and control method thereof capable of utilizing a software to automatically power down/up a transmitter to reduce power consumption.

2. Description of the Prior Art

When a conventional network device is not successfully linked with a link partner, a transmitter of the conventional network device still sends signals constantly and tries to link with the link partner. In this way, unnecessary power consumption is increased.

### SUMMARY OF THE INVENTION

It is therefore one of the objectives of the present invention to provide a network device and control method thereof capable of utilizing a software to automatically power down/up a transmitter to reduce power consumption, so as to solve the above problem.

In accordance with an embodiment of the present invention, a control method for a network device comprising a transmitter and a receiver is disclosed. The control method comprises: executing a software to calculate a first predetermined time and drive the transmitter to generate a network linking signal and output the network linking signal by the transmitter; executing the software to poll a link status of the network device and a link partner to generate a first detecting result; and executing the software to determine whether to power down the transmitter according to the first detecting result and the first predetermined time.

In accordance with an embodiment of the present invention, a network device is disclosed. The network device comprises: a receiver, a transmitter, a storage unit, and a processing unit. The storage unit is utilized for storing a software, and the processing unit is coupled to the receiver, the transmitter, and the storage unit, and utilized for reading the software from the storage unit and executing the software to execute following operations: calculating a first predetermined time and driving the transmitter to generate a network linking signal and output the network linking signal by the transmitter; polling a link status of the network device and a link partner to generate a first detecting result; and determining whether to power down the transmitter according to the first detecting result and the first predetermined time.

Briefly summarized, the network device and control method thereof disclosed by the present invention can utilize a software to automatically power down the transmitter to reduce power consumption of the network device when the network device does not link with any link partner by detecting a link status of the network device and the link partner, so as to save power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a network device in accordance with an embodiment of the present invention.

FIG. 2 is a flowchart illustrating a method employed for controlling the network device shown in FIG. 1 according to an exemplary embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

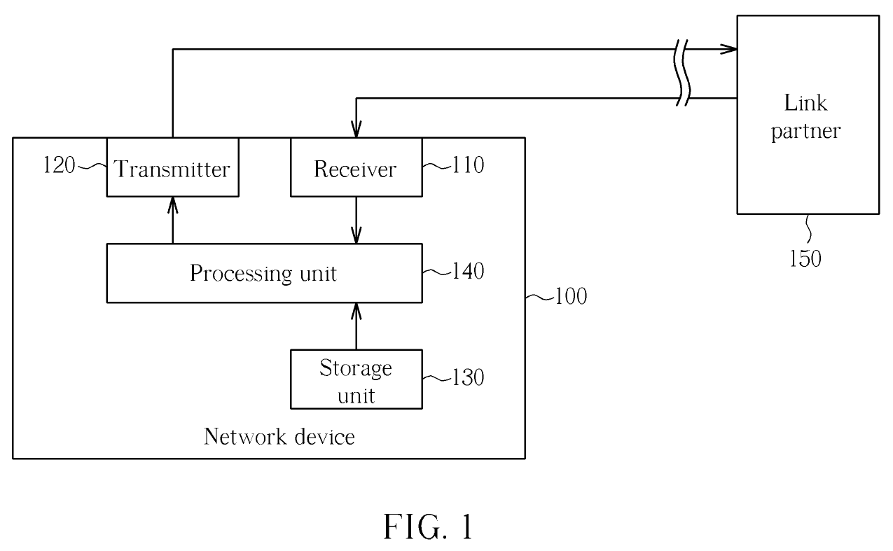

Please refer to FIG. 1. FIG. 1 shows a simplified block diagram of a network device 100 in accordance with an embodiment of the present invention. As shown in FIG. 1, the network device 100 comprises: a receiver 110, a transmitter 120, a storage unit 130, and a processing unit 140. The network device 100 can operates in a power saving mode. The storage unit 130 is utilized for storing a software, and the processing unit 140 is coupled to the receiver 110, the transmitter 120, and the storage unit 130, and utilized for reading the software from the storage unit 130 and executing the software to execute following operations: calculating a first predetermined time and driving the transmitter 120 to generate a network linking signal and output the network linking signal by the transmitter 120; polling a link status of the network device 100 and a link partner 150 to generate a first detecting result; and determining whether to power down the transmitter 120 according to the first detecting result and the first predetermined time. When the first detecting result indicates that the network device 100 can not establish a connecting link with the link partner 150 successfully and the first predetermined time is over, the processing unit 140 executes the software to power down the transmitter 120 and calculate a second predetermined time to detect whether the receiver 110 receives any network signal corresponding to the link partner 150 to generate a second detecting result. When the second detecting result indicates that the receiver 110 receives the network signal corresponding to the link partner 150, the processing unit 140 executes the software to power up the transmitter 120 to try to establish the connecting link between the network device 100 and the link partner 150. When the second detecting result indicates that the receiver 110 does not receive the network signal corresponding to the link partner 150 and the second predetermined time is over, the processing unit 140 executes the software to power up the transmitter 120 to try to establish the connecting link between the network device 100 and the link partner 150.

When an auto-negotiation mechanism of the network device 100 is enabled, the network linking signal is a Fast Link Pulse Bursts (FLP Bursts) signal. When an auto-negotiation mechanism of the network device 100 is disabled and a transmission rate of the network device 100 is 100 Mbps, the network linking signal is a Multi-level transmit-3 Idle (MLT-3 Idle) signal. When an auto-negotiation mechanism of the network device 100 is disabled and a transmission rate of the network device 100 is 10 Mbps, the network linking signal is a Normal Link Pulse (NLP) signal.

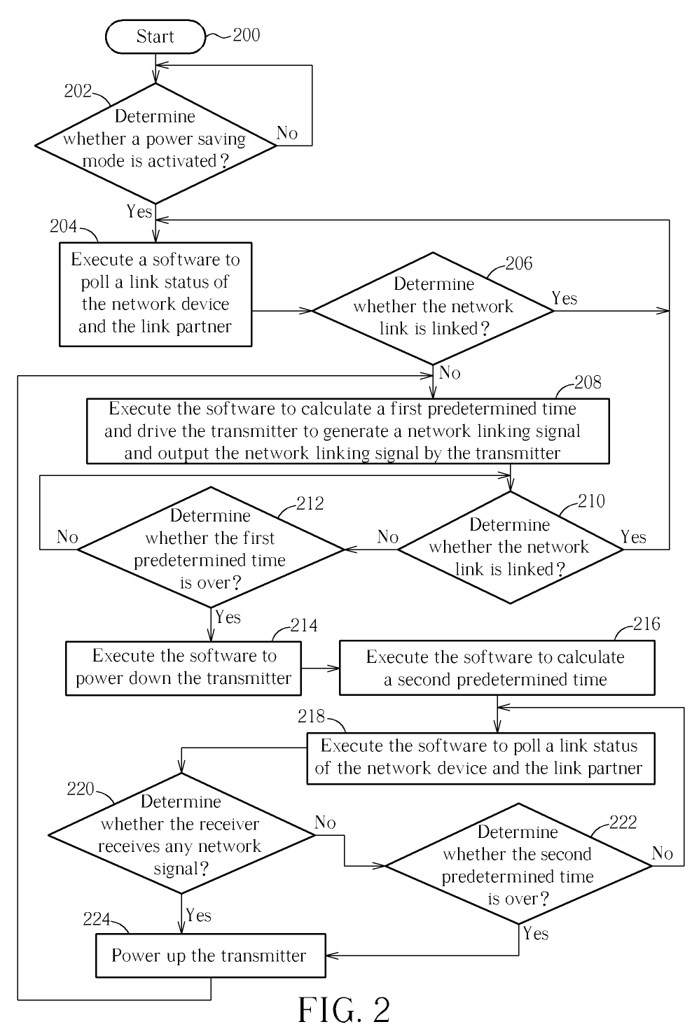

Please refer to FIG. 2. FIG. 2 is a flowchart illustrating a method employed for controlling the network device 100 shown in FIG. 1 according to an exemplary embodiment of the present invention. Please note that, provided substantially the same result is achieved, the steps of the flow shown in FIG. 2 need not be in the exact order shown and need not be contiguous; that is, other steps can be intermediate. The control method includes the following steps:

Step 200: Start.

Step 202: Determine whether a power saving mode is activated. If yes, go to Step 204.

Step 204: Execute a software to poll a link status of the network device and the link partner.

Step 206: Determine whether the network link is linked. If no, go to Step 208; otherwise, go back to step 204.

Step 208: Execute the software to calculate a first predetermined time and drive the transmitter to generate a network linking signal and output the network linking signal by the transmitter.

Step 210: Determine whether the network link is linked. If yes, go back to Step 204; otherwise, go to step 212.

Step 212: Determine whether the first predetermined time is over. If yes, go to Step 214; otherwise, go back to step 208.

Step 214: Execute the software to power down the transmitter.

Step 216: Execute the software to calculate a second predetermined time.

Step 218: Execute the software to poll a link status of the network device and the link partner.

Step 220: Determine whether the receiver receives any network signal. If yes, go back to Step 224; otherwise, go to step 222.

Step 222: Determine whether the second predetermined time is over. If yes, go to Step 224; otherwise, go back to step 218.

Step 224: Power up the transmitter 130.

Briefly summarized, the network device and control method thereof disclosed by the present invention can utilize a software to automatically power down the transmitter to reduce power consumption of the network device when the network device does not link with any link partner by detecting a link status of the network device and the link partner, so as to save power.

Those skilled in the art will readily observe that numerous modifications and alterations of the device and method may be made while retaining the teachings of the invention.

What is claimed is:

1. A control method for a network device comprising a transmitter and a receiver, the control method comprising:
executing a software to calculate a first predetermined time and drive the transmitter to generate a network linking signal and output the network linking signal by the transmitter;
executing the software to poll a link status of the network device and a link partner to generate a first detecting result; and
executing the software to determine whether to power down the transmitter according to the first detecting result and the first predetermined time.

2. The control method of claim 1, further comprising:
when the first detecting result indicates that the network device can not establish a connecting link with the link partner successfully and the first predetermined time is over, executing the software to power down the transmitter and calculate a second predetermined time to detect whether the receiver receives any network signal corresponding to the link partner to generate a second detecting result;
when the second detecting result indicates that the receiver receives the network signal corresponding to the link partner, executing the software to power up the transmitter to try to establish the connecting link between the network device and the link partner; and
when the second detecting result indicates that the receiver does not receive the network signal corresponding to the link partner and the second predetermined time is over, executing the software to power up the transmitter to try to establish the connecting link between the network device and the link partner.

3. The control method of claim 1, wherein when an auto-negotiation mechanism of the network device is enabled, the network linking signal is a Fast Link Pulse Bursts (FLP Bursts) signal.

4. The control method of claim 1, wherein when an auto-negotiation mechanism of the network device is disabled and a transmission rate of the network device is 100 Mbps, the network linking signal is a Multi-level transmit-3 Idle (MLT-3 Idle) signal.

5. The control method of claim 1, wherein when an auto-negotiation mechanism of the network device is disabled and a transmission rate of the network device is 10 Mbps, the network linking signal is a Normal Link Pulse (NLP) signal.

6. A network device, comprising:
a receiver;
a transmitter,
a storage unit, for storing a software; and
a processing unit, coupled to the receiver, the transmitter, and the storage unit, for reading the software from the storage unit and executing the software to execute following operations:
calculating a first predetermined time and driving the transmitter to generate a network linking signal and output the network linking signal by the transmitter;
polling a link status of the network device and a link partner to generate a first detecting result; and
determining whether to power down the transmitter according to the first detecting result and the first predetermined time.

7. The network device of claim 6, wherein the processing unit further reads the software from the storage unit and executes the software to execute following operations:
when the first detecting result indicates that the network device can not establish a connecting link with the link partner successfully and the first predetermined time is over, executing the software to power down the transmitter and calculate a second predetermined time to detect whether the receiver receives any network signal corresponding to the link partner to generate a second detecting result;
when the second detecting result indicates that the receiver receives the network signal corresponding to the link partner, executing the software to power up the transmitter to try to establish the connecting link between the network device and the link partner; and
when the second detecting result indicates that the receiver does not receive the network signal corresponding to the link partner and the second predetermined time is over, executing the software to power up the transmitter to try to establish the connecting link between the network device and the link partner.

8. The network device of claim 6, wherein when an auto-negotiation mechanism of the network device is enabled, the network linking signal is a Fast Link Pulse Bursts (FLP Bursts) signal.

9. The network device of claim 6, wherein when an auto-negotiation mechanism of the network device is disabled and a transmission rate of the network device is 100 Mbps, the network linking signal is a Multi-level transmit-3 Idle (MLT-3 Idle) signal.

10. The network device of claim 6, wherein when an auto-negotiation mechanism of the network device is disabled and a transmission rate of the network device is 10 Mbps, the network linking signal is a Normal Link Pulse (NLP) signal.
